(19) United States
(12) Patent Application Publication
(10) Pub. No.: US 2011/0257862 A1
(43) Pub. Date: Oct. 20, 2011

(54) METHOD FOR CONTROLLING AUTOMATIC STOP AND START OF VEHICLE

(75) Inventors: Chan Kyu Lee, Yongin (KR); Dae Youn Um, Suwon (KR); Eun Muk Lim, Ansan (KR); Suk Hwan Cho, Hwaseong (KR); Si Hyoung Lee, Seongnam (KR)

(73) Assignees: KIA MOTORS CORPORATION, Seoul (KR); HYUNDAI MOTOR COMPANY, Seoul (KR)

(21) Appl. No.: 12/947,353

(22) Filed: Nov. 16, 2010

(30) Foreign Application Priority Data
Apr. 14, 2010 (KR) 10-2010-0034409

(51) Int. Cl. B60W 40/10

(52) U.S. Cl. 701/96

(57) ABSTRACT

Disclosed is a control method for use in a system for controlling a distance between vehicles. The method comprises a) controlling, in response to the leading vehicle's deceleration, deceleration of the control vehicle; b) controlling stop speed of the control vehicle so that the control vehicle approaches the leading vehicle at a constant speed without stopping; c) controlling the control vehicle to stop smoothly exactly at a position spaced from the leading vehicle by a predetermined stop distance; and d) controlling the start of the control vehicle after determining whether the leading vehicle has started or moved forward.

### CROSS-REFERENCE TO RELATED APPLICATION

The present application claims priority to Korean Patent Application No. 10-2010-0034409, filed on Apr. 14, 2010, the entire contents of which are incorporated herein for all purposes by this reference.

### BACKGROUND

1. Technical Field

The present invention relates to a method for controlling a distance between vehicles, and more particularly to a method for optimally controlling automatic stop and start of a vehicle using a system for controlling a distance between vehicles.

2. Background Art

Some vehicles are equipped with an adaptive cruise control (ACC) system, that is, a system for controlling a distance between vehicles. A recent ACC system provides a full speed range control including a function of stop and go.

The full speed range ACC system may secure the credibility for sensing and controlling obstacles in a short distance area at a low speed, and may quickly recognize a vehicle approaching the vehicle equipped with the ACC system, such that the vehicle can be adequately controlled.

In some vehicles, the ACC system is functionally coupled with a local optical radar that can sense a wide-angle at a short distance. Accordingly, in case of a vehicle with such system, other vehicles running ahead of the vehicle on the same road as well as other vehicles running on an adjacent road can be recognized at a short distance.

Some methods for controlling a distance between vehicles were proposed, as disclosed in Japanese Patent Application Publication Nos. 2004-322729, 2002-067733, and 2000-043618, which are incorporated herein by reference.

These methods, however, are disadvantageous in some respects. For example, some of the methods cannot control the vehicle to start in response to the start of a vehicle ahead of the vehicle. Some of the methods cannot control the decelerating speed and/or stopping speed of the vehicle. Moreover, as shown in FIG. 1, a view for explaining the relationship of a relative distance and a request stop distance between a leading vehicle 100 and a following vehicle 200 equipped with a system for performing the control method(s), even when the vehicle 100 stops, the vehicle 200 is controlled to stop well prior to approaching the vehicle 100 in spite of quite a distance error to fit the relative speed. In addition, some of the methods may not control the vehicle to stop at a targeted position and may sacrifice driver's driving feel.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In an aspect, the present invention provides a method for optimally controlling automatic stop and start for use in a system for controlling a distance between vehicles. The control method is performed in a deceleration control area, a stop speed control area, a stop control area and a start control area.

In the deceleration control area, in response to the leading vehicle's deceleration, deceleration of the control vehicle is controlled by considering a relative acceleration, a relative speed and a relative distance of the control vehicle with respect to the leading vehicle.

In the stop speed control area, stop speed of the control vehicle is controlled so that the control vehicle approaches the leading vehicle at a constant speed without stopping, prior to entering the deceleration control area.

In the stop control area, the control vehicle is controlled to stop smoothly exactly at a position spaced from the leading vehicle by a predetermined stop distance; and

In the start control area, the control vehicle is controlled to start by the result of determination of whether the leading vehicle has started or moved forward.

In another aspect, the present invention provides a system for controlling a distance between vehicles. A stop & go system is a system for enabling automatic stop and start in a conventional system for controlling a distance between vehicles. The stop & go system comprises an electronic control unit (ECU), a sensor and an actuator. The ECU includes an exclusive ECU for the stop & go system or is included in a conventional brake control system (i.e., electronic stability control (ESC) system). The sensor for the stop & go system includes a sensor for sensing front objects such as radar, lidar and vision. Although one sensor is used basically, two or more sensors may be simultaneously used in order to improve reliability. The actuator includes an engine and brake.

### BRIEF DESCRIPTION OF THE DRAWINGS

FIG. 1 is a view for explaining the relationship of a relative distance and a request stop distance between a leading vehicle and a following vehicle in a system for controlling a distance between vehicles.

FIG. 2 is a view for explaining that a method for controlling a distance between vehicles according to an embodiment of the present invention is performed in a deceleration control area, a stop speed control area, a stop control area, and a start control area.

FIG. 3 is a flowchart of a method for optimally controlling automatic stop and start according to an embodiment of the present invention.

FIG. 4 is a detailed flowchart for a step of stop speed control and a step of stop prevention control shown in FIG. 3.

FIG. 5 is a detailed flowchart for a step of stop control shown in FIG. 3.

FIG. 6 is a detailed flowchart for a step of decision of stop condition shown in FIG. 5.

FIG. 7 is a detailed flowchart for a step of start control shown in FIG. 3.

FIG. 8 is a view for illustrating the speed of a leading vehicle, the speed of a following vehicle, and a relative distance between the vehicles when the following vehicle is optimally controlled by a method according to an embodiment of the present invention.

### DETAILED DESCRIPTION

With reference to the accompanying drawings, reference will now be made in detail to exemplary embodiments of the present invention so that those skilled in the art may embody easily. But, the present invention may be embodied in various embodiments, which are not limited by the embodiments illustrated herein. In the accompanying drawings, some elements regardless of the description of the present invention are omitted in order to describe the present invention clearly, and, like reference numerals refer to the like elements throughout.

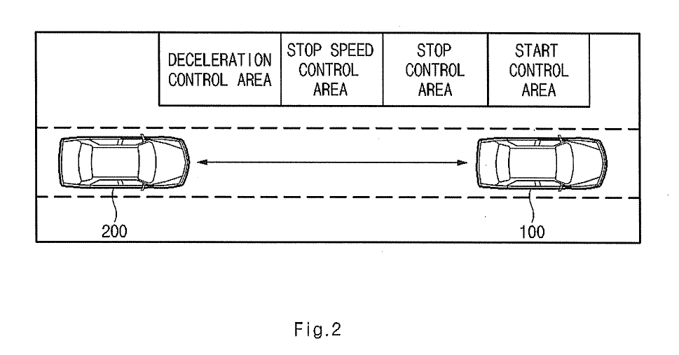

As shown in FIG. 2, a method for controlling a distance between vehicles according to the present invention is performed in 4 areas: a deceleration control area, a stop speed control area, a stop control area, and a start control area. The reference number 200 is referred to a vehicle (“control vehicle”) in which the control method is performed and the reference number 100 is referred to a vehicle (“leading vehicle”) running ahead of the vehicle 200, unless otherwise specified.

The deceleration control area refers to an area in which the deceleration of the control vehicle 200 is controlled considering a relative acceleration, a relative speed and a relative distance of the control vehicle 200 with respect to the leading vehicle 100 according as the leading vehicle 100 decelerates.

The stop speed control area refers to an area in which the stop speed of the control vehicle 200 is controlled so that the control vehicle 200 may keep constant the approaching speed without stopping prior to entering the deceleration control area.

The stop control area refers to an area in which the control vehicle 200 is controlled to stop at a targeted position exactly and smoothly.

The start control area refers to an area in which whether the leading vehicle 100 is started or moved forward a little is determined and according to the determination the control vehicle 200 is controlled to start.

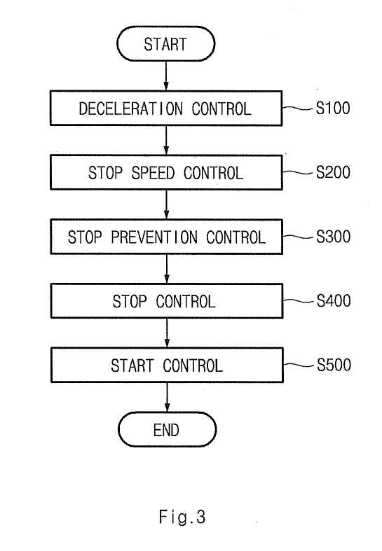

Referring to FIG. 3, a method for optimally controlling a distance between vehicles according to an embodiment of the present invention is described.

The method includes a step of deceleration control S100, a step of stop speed control S200, a step of stop prevention control S300, a step of stop control S400 and a step of start control S500.

In step S100, according as the leading vehicle 100 decelerates, the control vehicle 200 is controlled to decelerate considering a relative acceleration, a relative speed and a relative distance of the control vehicle 200 with respect to the leading vehicle 100.

In step S200, the control vehicle 200 is controlled, prior to entering the deceleration control area, to approach the leading vehicle 100 at a constant speed without stopping.

In step S300, in case where the leading vehicle 100 stops and the control vehicle 200 is going to stop at a position farther than a request stop distance from the control vehicle 200, the control vehicle 200 is controlled to move to a position that meets the request stop distance without stopping by adjusting a value of the relative distance with regard to the relative speed of the control vehicle 200.

In step S400, the control vehicle 200 is controlled to be able to stop at an exact position that meets the request stop distance smoothly.

In step S500, whether the leading vehicle 100 is started or moved forward a little is determined and the control vehicle 200 is controlled to start according to the determination result.

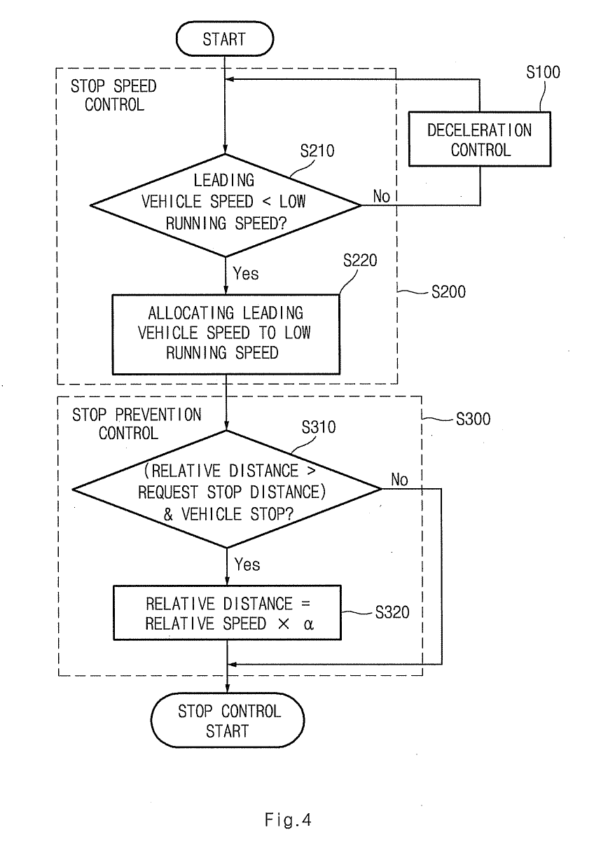

The above-described steps of S100 to S500 will now be explained in more detail with reference to FIGS. 4 to 7.

FIG. 4 is a detailed flowchart for a step of stop speed control and a step of stop prevention control shown in FIG. 3.

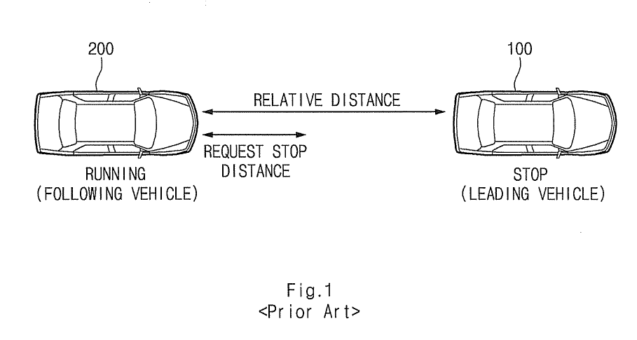

According to a conventional TJA (Traffic Jam Assist) system, the amount of the deceleration of the control vehicle is calculated from a relative distance between the control vehicle and the leading vehicle, a relative speed of the control vehicle with regard to the leading vehicle, and the acceleration of the leading vehicle. In case where the leading vehicle stops ahead of the control vehicle, however, there is a problem that the control vehicle may stop well prior to approaching the leading vehicle in spite of quite a distance error to fit the relative speed, as described above with reference to FIG. 1. In order to overcome the problem, the control method according to the present invention defines the stop speed control area.

Referring to FIG. 4, in step S210, whether the speed of the leading vehicle 100 is lower than a predetermined low driving speed is determined. If it is determined that the speed of the leading vehicle 100 is not lower, the step S100 is performed.

On the other hand, if it is determined that the speed of the leading vehicle 100 is lower, the speed of the leading vehicle 100 is set to the predetermined low driving speed (S220).

In other words, the step of stop speed control S200 decides whether the speed of the leading vehicle 100 is lower than the low driving speed in order to decide whether the leading vehicle 100 stops or not, and, if not, sets the speed of the leading vehicle 100 to the low driving speed so that the control vehicle 200 may drive at the low driving speed. Accordingly, it is possible to prevent that the control vehicle 200 stops at a position longer than the request stop distance.

In case where the control vehicle 200 stops at a position longer than the request stop distance in spite of the above-described step of stop speed control S200, the control method may, optionally, include a step of stop prevention control S300. That is, in step S300, in case where the leading vehicle 100 stops and the control vehicle 200 is going to stop at a position longer than the request stop distance, a value of the relative distance with respect to the relative speed of the control vehicle 200 may be adjusted so that the control vehicle 200 moves to the request stop distance without stopping.

More specifically, in case where the control vehicle 200 is going to stop at a position longer than the request stop distance, whether the relative distance is longer than the request stop distance and whether the control vehicle 200 is stopped are determined (S310).

If it is determined that the relative distance is longer than the request stop distance and the control vehicle 200 is stopped, a value of the relative distance with respect to the relative speed of the control vehicle 200 is adjusted (S320). If, however, it is determined that the relative distance is not longer than the request stop distance or the control vehicle 200 is not stopped, or if the value of the relative distance with respect to the relative speed of the control 200 is adjusted, the step of stop control S400 is performed.

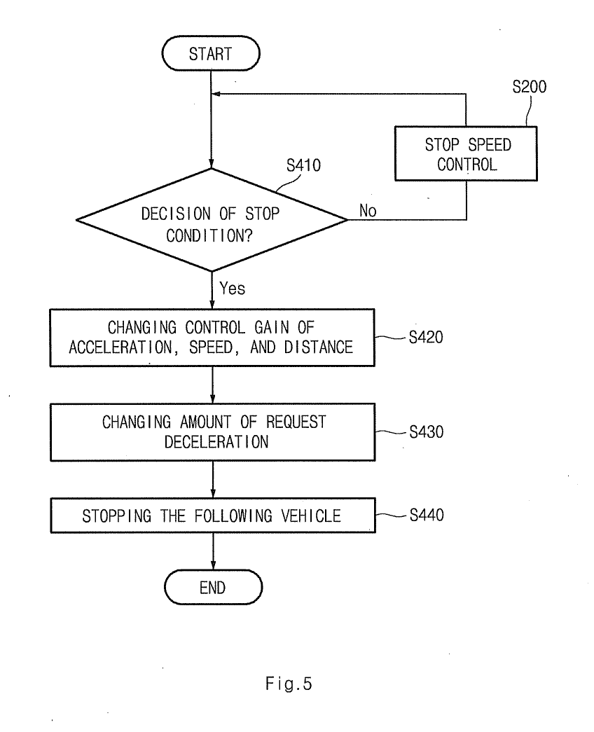

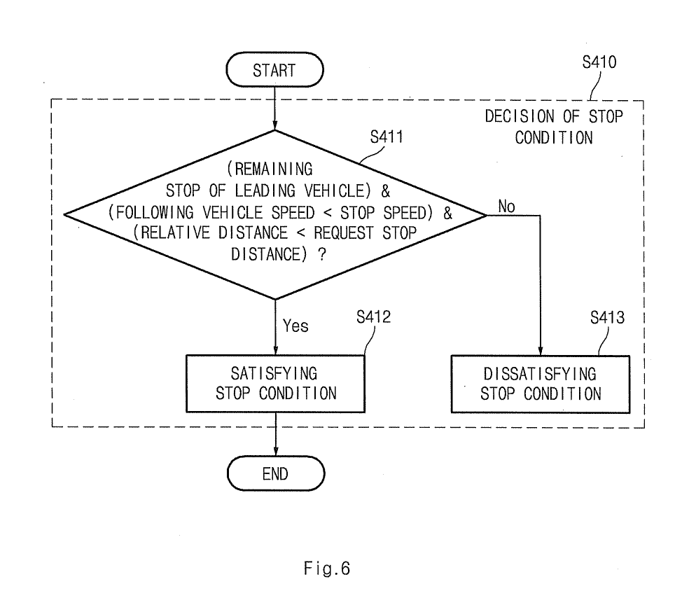

FIG. 5 is a detailed flowchart for a step of stop control shown in FIG. 3, and FIG. 6 is a detailed flowchart for a step of stop control decision shown in FIG. 5.

In general, in order to stably stop a vehicle and remain the stop status, the amount of deceleration should be greater than the one in a general deceleration control.

Referring to FIG. 5, in step S400, whether predetermined stop conditions of the control vehicle 200 are satisfied is determined (S410). Here, referring to FIG. 6, in step S410, for example, whether the leading vehicle 100 stops or not, whether the speed of the control vehicle 200 is lower than the stop speed or not, and whether the relative distance is shorter than the request stop distance may be determined (S411).

If any of the predetermined stop conditions is not satisfied, it is determined that the stop condition of the control vehicle 200 is not satisfied (S413), in which case the step S200 is performed.

On the other hand, if it is determined that the predetermined stop conditions are satisfied, it is determined that the stop condition of the control vehicle 200 is satisfied (S412). In this case, control gains of acceleration, a speed and a distance are changed (S420), and then, a required deceleration is changed on the basis of the changed control gains (S430). According to the changed deceleration, the control vehicle 200 can stably stop (S440).

Namely, stop conditions of the control vehicle 200 are determined, and a required deceleration is changed by changing the control gains of acceleration/speed/distance of the control vehicle 200 so that the control vehicle 200 is stably stopped.

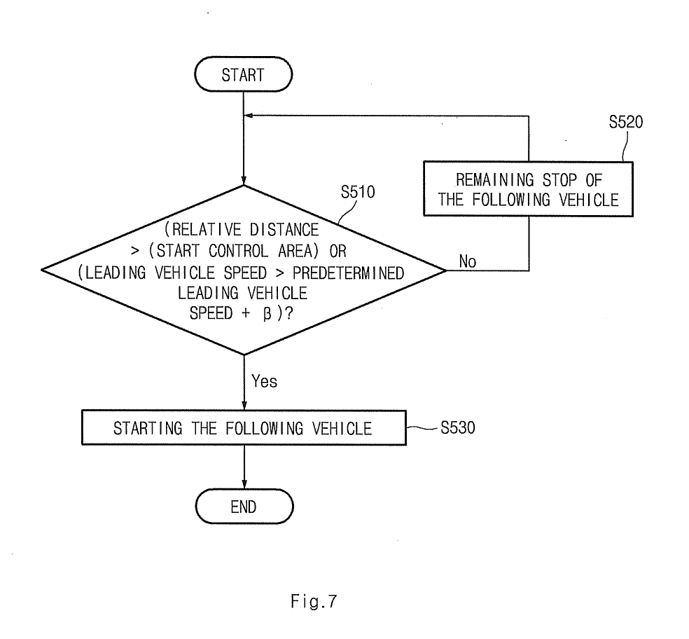

FIG. 7 is a detailed flowchart for a step of start control shown in FIG. 3.

In general, for controlling a distance between vehicles, a control vehicle should be controlled to stop if the leading vehicle stops, and start if the leading vehicle starts. If the leading vehicle moves, the relative distance from the control vehicle to the leading vehicle changes. The control vehicle should be controlled to move in order to fit the request distance. But, if the leading vehicle moves by a short distance (for example, 1 m or so), it may be difficult to control the control vehicle to be moved corresponding to the moved distance because of the response time of an actuator, and also, such a control may cause an excessive jolt occasionally.

In order to prevent the problems, according to an embodiment of the present invention, the control vehicle 200 is controlled to start in only case where the leading vehicle 100 is outside the start control area.

Referring to FIG. 7, in the step of start control S500, whether the relative distance is longer than the length of the start control area and whether the speed of the leading vehicle 100 is higher than a predetermined speed of the leading vehicle 100 are determined (S510).

If it is determined that the relative distance is not longer than the length of the start control area and the speed of the leading vehicle 100 is not higher than the predetermined speed of the leading vehicle 100, the control vehicle 200 remains stopped (S520).

If, on the other hand, it is determined that the relative distance is longer than the length of the start control area or the speed of the leading vehicle 100 is higher than the predetermined speed of the leading vehicle 100, the control vehicle 200 is controlled to start (S530).

Preferably, the length of the start control area may be determined by tuning. Although the range of the start control area is determined by tuning, the range needs to satisfy at least a value of request stop distance +α. It means that the range of the start control area is required to be larger than the request stop distance. The amount of +α is determined by tuning and a driving environment.

In addition, in order not to respond to a little movement of the leading vehicle 100, and in order to restrict the request acceleration according to a small distance error, a dead zone for the distance error may, suitably, be set in the start control area.

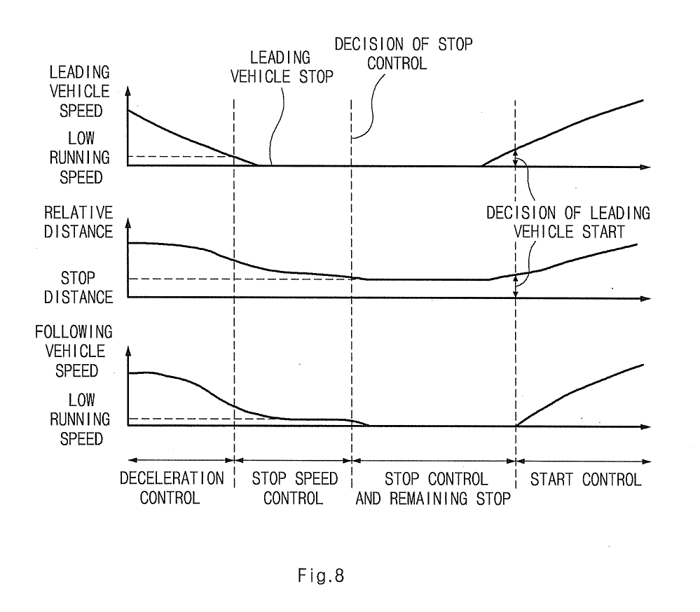

FIG. 8 is a view for illustrating the speed of a leading vehicle, the speed of a following vehicle, and a relative distance between the vehicles when the following vehicle is optimally controlled by a method according to an embodiment of the present invention.

As shown in FIG. 8, according to an embodiment of the present invention, if the speed of the leading vehicle 100 is lower than the low running speed, the control vehicle 200 is controlled to approach the leading vehicle 100 at a constant speed within a specific distance, and the stop conditions of the control vehicle 200 is determined and based on the determination, the control vehicle 200 is controlled to smoothly stop and remain the stop status. Besides, the control vehicle 200 is controlled to smoothly start in response to the start of the leading vehicle 100 while not responding to a little movement of the leading vehicle 100.

With the control methods according to the present invention, the control vehicle 200 can smoothly stop while not deteriorating driving quality of a driver and can stop exactly at a position required by the driver.

The foregoing description of the present invention is intended to be illustrative, and those of ordinary skill in the art will understand that the present invention may be changed into other specific forms without modifying technical conceptions or essential characteristics according to the present invention. Therefore, it must be understood that the above-described embodiment is to be illustrative not to be definitive.

The present invention is intended to fall within the scope of the following appended claims not within the scope of the detailed description, and accordingly, it must be understood that the meaning and scope of the appended claims and all such changes, modifications and variations induced by the equivalents are included in the scope of the present invention.

What is claimed is:

1. A method for optimally controlling a distance between a control vehicle and a leading vehicle running ahead of the control vehicle in a system for controlling a distance between vehicles that enables automatic stop and start, the method comprising the steps of:
a) controlling, in response to the leading vehicle's deceleration, deceleration of the control vehicle by considering a relative acceleration, a relative speed and a relative distance of the control vehicle with respect to the leading vehicle;
b) controlling stop speed of the control vehicle so that the control vehicle approaches the leading vehicle at a constant speed without stopping;
c) controlling the control vehicle to stop smoothly exactly at a position spaced from the leading vehicle by a predetermined stop distance; and
d) controlling the start of the control vehicle after determining whether the leading vehicle has started or moved forward.

2. The method of claim 1, wherein the step b) comprises:
b-1) determining whether the speed of the leading vehicle is lower than a predetermined low running speed;
b-2) returning to the step a) if it is determined that the speed of the leading vehicle is not lower than the predetermined low running speed; and
b-3) setting the leading vehicle speed to the predetermined low running speed if it is determined that the speed of the leading vehicle is lower than the predetermined low running speed.

3. The method of claim 2, wherein the step b) further comprises a step of stop prevention control in which in case where the leading vehicle stops and the control vehicle is going to stop at a position farther than a request stop distance of the control vehicle, a value of a relative distance with respect to a relative speed of the control vehicle is adjusted so that the control vehicle moves, without stopping, to a position that meets the request stop distance.

4. The method of claim 3, wherein the step of stop prevention control comprises:
determining whether the relative distance is longer than the request stop and whether the control vehicle is stopped, in case where the control vehicle is going to stop at a position farther than the request stop distance;
adjusting the value of the relative distance with respect to the relative speed of the control vehicle, if it is determined that the relative distance is longer than the request stop and the control vehicle is stopped; and
performing the step c), if it is determined that the relative distance is not longer than the request stop or the control vehicle is not stopped.

5. The method of claim 1, wherein the step c) comprises:
c-1) determining whether predetermined stop conditions of the control vehicle are satisfied;
c-2) returning to the step b), if it is determined that the predetermined stop conditions are not satisfied;
c-3) changing control gains of an acceleration, a speed and a distance, respectively, if it is determined that the predetermined stop conditions are satisfied;
c-4) changing a request deceleration on the basis of the changed control gains; and
c-5) stopping stably the control vehicle according to the changed request deceleration.

6. The method of claim 5, wherein the step c-1) comprises:
determining whether the predetermined stop conditions are satisfied by determining whether the leading vehicle remains stopped, whether the speed of the control vehicle is lower than the stop speed, and whether the relative distance is lower than the request stop distance;
concluding that stop conditions of the control vehicle are satisfied if it is determined that the predetermined stop conditions are satisfied; and
concluding that stop conditions of the control vehicle are not satisfied if it is determined that the predetermined stop conditions are not satisfied.

7. The method of claim 1, wherein the step d) comprises:
d-1) determining whether the relative distance is longer than the length of the control area where the step d) is expected to be performed or whether the speed of the leading vehicle is higher than a predetermined speed of the leading vehicle;
d-2) controlling the control vehicle to remain stopped, if it is determined that the relative distance is not longer than the length of the start control area and the speed of the leading vehicle is not higher than the predetermined speed of the leading vehicle; and
d-3) controlling the control vehicle to start, if it is determined that the relative distance is longer than the length of the start control area or the speed of the leading vehicle is higher than the predetermined speed of the leading vehicle.

8. The method of claim 7, wherein the range of the start control area is determined by tuning, the range needs to satisfy at least a value of request stop distance +α, which means that the range of the start control area is required to be larger than the request stop distance, and the amount of +α is determined by tuning and a driving environment.

9. The method of claim 7, wherein, a dead zone for the distance error is set in the start control area so that the control vehicle may not respond to a little movement of the leading vehicle the request acceleration according to a small distance error may be limited.
